(19) United States
(12) Patent Application Publication
(10) Pub. No.: US 2006/0223900 A1
(43) Pub. Date: Oct. 5, 2006

(54) Member formed from foamed material, feed/transport roller, and sheet-separation roller

(75) Inventor: Shuhei Noda, Yokohama-shi (JP)

Correspondence Address: GOMEZ INTERNATIONAL PATENT OFFICE, LLC, 1501 N. RODNEY STREET, SUITE 101, WILMINGTON, DE, 19806, US

(73) Assignee: Hokushin Corporation

(21) Appl. No.: 11/094,015

(22) Filed: Mar. 29, 2005

(51) Int. Cl. C08G 18/00

(52) U.S. Cl. 521/172

(57) ABSTRACT

The present invention provides a foamed member, a feed/transport roller, and a sheet-separation roll, which prevent generation of anomalous sounds during feeding, transporting, or separating paper sheets. The foamed member is formed from polyurethane foam, the polyurethane foam being produced by reacting a polyisocyanate compound with a first polyol which is selected from among a polytetramethylene ether glycol and a diene polyol having at least one double bond in the molecular chain thereof and the fiest polyol has a number average molecular weight of 1,000 to 4,000, in the presence of a cross-linking agent including a short-chain diol and a second polyol having at least three functionalities and a number average molecular weight of 500 to 5,000, wherein the foamed member is formed from a foamed reaction cured product having a foamed product density (weight of the product in a mold [g]/volume of the mold [cm³]) of 0.3 to 0.9 [g/cm³] and exhibits a ratio of maximum value (Max) of an output waveform to minimum value (Min) of the output waveform (Max/Min ratio) falling within a range of 1.00 to 1.40, the output waveform being obtained during measurement of friction coefficient.

### BACKGROUND OF THE INVENTION

1. Field of the Invention

The present invention relates to a member formed from a foamed material (hereinafter referred to as “foamed member”), the member comprising polyurethane foam, and, more particularly, to a feed/transport roller (i.e., a roller for feeding or transporting sheet material) and a sheet-separation roller (i.e., a roller for separating paper sheets) for use in a variety of OA (office automation) machines such as copying machines, facsimiles, and printers.

2. Background Art

Conventionally, feed/transport rollers for use in a variety of OA machines have been required to have excellent sheet transportation capacity and wear resistance. In recent years, attention has been drawn to a critical problem, which is a certain type of peculiar noise attributed to vibration caused by friction between a paper sheet and a roller during feeding of the paper sheet.

Among the rollers used in an OA machine, a sheet-separation roller used for preventing stacking of paper sheets in a sheet feed section is generally formed of polyurethane foam, from the viewpoint of wear resistance and staining prevention with respect to an original sheet. When the sheet-separation roller is slid while being in contact with a sheet feed belt after completion of separating of sheets, friction- or vibration-related noises (a buzzing noise and/or a squeaky sound; hereinafter referred to anomalous noises) are generated.

Conventionally, a variety of countermeasures has been taken for preventing such anomalous noises. The present applicant previously proposed a rubber member for separating paper sheets employed in a sheet feed section of an OA machine, wherein the rubber member is formed of a rubber elastomer comprising a polyurethane formed from a polyester-polyol having an ester concentration of 2 to 8 mmol/g and a number average molecular weight of 500 to 5,000 (see Japanese Patent Application Laid-Open (kokai) No. 2002-275233).

According to the technique, anomalous noises are prevented through appropriate control of the ester concentration and temperature-dependency of rebound resilience. However, the technique is effective only when the sheet separation roller is formed of a material having high hardness (50° or more (JIS A)).

The present applicant also proposed a feed/transport roller which has low hardness but excellent durability, which is not affected by paper dust, so as to maintain consistent friction coefficient, and which is provided so as to prevent anomalous noises (see Japanese Patent Application Laid-Open (kokai) No. 2003-165635). However, the above effects of the roller are insufficient, and further improvement has been awaited.

### SUMMARY OF THE INVENTION

The present inventors have accomplished the present invention in view of the foregoing. Thus, an object of the invention is to provide a foamed member which can prevent generation of anomalous noises. Another object of the invention is to provide a feed/transport roller which can prevent generation of anomalous noises. Still another object of the invention is to provide a sheet-separation roller which can prevent generation of anomalous noises.

The present inventors have carried out extensive studies in an effort to attain the above objects, and have found that a foamed member which is formed from polyurethane foam having a specific composition and which exhibits a ratio of maximum value (Max) of an output waveform to minimum value (Min) of the output waveform (Max/Min ratio) falling within a range of 1.00 to 1.40, the output waveform being obtained during measurement of friction coefficient, remarkably effectively prevents generation of anomalous noises. The present invention has been accomplished on the basis of this finding.

Accordingly, in a first aspect of the present invention, there is provided a foamed member formed from polyurethane foam, the polyurethane foam being produced by reacting a polyisocyanate compound with

a first polyol which is selected from among

a polytetramethylene ether glycol and

a diene polyol having at least one double bond in the molecular chain thereof and which has a number average molecular weight of 1,000 to 4,000, in the presence of

a cross-linking agent comprising

a short-chain diol and

a second polyol having at least three functionalities and a number average molecular weight of 500 to 5,000, wherein the foamed member comprises a foamed reaction cured product having a foamed product density (weight of the product in a mold [g]/volume of the mold [cm³]) of 0.3 to 0.9 [g/cm³] and exhibits a ratio of maximum value (Max) of an output waveform to minimum value (Min) of the output waveform (Max/Min ratio) falling within a range of 1.00 to 1.40, the output waveform being obtained during measurement of friction coefficient.

The Max/Min ratio can fall within a range of 1.00 to 1.20.

The cross-linking agent can contain the second polyol in an amount of 5 to 40 mol%.

The polyisocyanate compound can be 4,4′-diphenylmethane diisocyanate (MDI).

The short-chain diol can have a number average molecular weight of 80 to 160.

The diene polyol can be selected from a butadiene polyol and an isoprene polyol.

The diene polyol can be produced through dehydration condensation of a dibasic acid and 1,9-nonanediol and 2-methyloctanediol.

The second polyol can contain, in the molecule thereof, an ether moiety and an ester moiety.

The second polyol can have a molecular weight falling within a range of 1,800 to 5,000.

In a second aspect of the present invention, there is provided a feed/transport roller comprising the aforementioned foamed member.

In a third aspect of the present invention, there is provided a sheet-separation roller comprising the aforementioned foamed member.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a schematic illustration of a test apparatus employed in the Examples and Comparative Examples.

FIG. 2 is a graph showing the results of Examples 1-6 and Comparative Examples 1-11; and particularly the ratios of maximum value of an output waveform to minimum value of the output waveform (the output waveform obtained during measurement of friction coefficient).

FIG. 3 is a graph showing dependency of friction coefficient on sheet feed rate investigated in Example 7 and Comparative Example 13.

FIG. 4 is a graph showing atmosphere-dependent variation in friction coefficient investigated in Example 7 and Comparative Example 13.

FIG. 5 is a graph showing dependency of friction coefficient on load investigated in Example 7 and Comparative Example 13.

FIG. 6 is a graph showing dependency of friction coefficient on the type of sheet investigated in Example 7 and Comparative Example 13.

### DETAILED DESCRIPTION OF PREFERRED EMBODIMENTS

The foamed member of the present invention is formed from a polyurethane foam which is produced by reacting a polyisocyanate compound with a first polyol which is selected from among a polytetramethylene ether glycol and a diene polyol having at least one double bond in the molecular chain thereof and the first polyol has a number average molecular weight of 1,000 to 4,000, in the presence of a cross-linking agent comprising a short-chain diol having a number average molecular weight of 80 to 160 and a second polyol having at least three functionalities and a number average molecular weight of 500 to 5,000.

The first polyol employed in the present invention is selected from a polytetramethylene ether glycol (PTMG) having a number average molecular weight of 1,000 to 4,000 and a diene polyol having at least one double bond in the molecular chain thereof and a number average molecular weight of 1,000 to 4,000.

Examples of the diene polyol having at least one double bond in the molecular chain thereof include a butadiene polyol and an isoprene polyol.

The diene polyol can be produced through dehydration condensation of a dibasic acid and 1,9-nonanediol and 2-methyloctanediol.

Examples of the polyisocyate compound reacted with the first polyol include 2,6-toluene diisocyanate (TDI), 4,4′-diphenylmethane diisocyanate (MDI), p-phenylene diisocyanate (PPDI), 1,5-naphthalene diisocyanate (NDI), and 3,3-dimethyldiphenyl-4,4′-diisocyanate (TODI). Of these, MDI is preferred, from the viewpoint of reactivity and cost.

Examples of the second polyol, serving as a cross-linking agent and having at least three functionalities and a number average molecular weight of 500 to 5,000, include a ether polyol and an ester polyol.

In the case where a polyol produced through dehydration condensation of a dibasic acid and 1,9-nonanediol and 2-methyloctanediol is employed as the diene polyol, the second polyol particularly preferably contains an ether moiety and an ester moiety in the molecule thereof, for the purpose of attaining both strength (wear resistance) and flexibility (friction force). The molecular weight of the second polyol particularly preferably falls within a range of 1,800 to 5,000, for the purpose of preventing anomalous noises.

The short-chain diol preferably has a number average molecular weight of 80 to 160. Examples of the short-chain diol include butanediol, pentanediol, hexanediol, and diethylene glycol.

The aforementioned raw materials are mixed at predetermined proportions, and the mixture is expansion-molded. In this case, an additive can be incorporated into the mixture. Examples of the additive include a foaming agent, a foaming-regulating agent, an anti-aging agent, and an antioxidant. The mixture can be foamed by use of a foaming agent. Alternatively, foaming can be performed through mechanical frothing in the presence of a foaming-regulating agent.

The foamed member of the present invention must have a foamed product density (i.e., weight of the product in a mold [g]/volume of the mold [cm³]) of 0.3 to 0.9 [g/cm³]. When the density is less than 0.3, Hs becomes excessively small, failing to attain sheet-separation performance, whereas when the density is in excess of 0.9, the foamed member assumes the form of virtually hard solid, and is affected by paper dust. Therefore, when the foamed member is employed as a feed/transport roller, particularly as a reverse roller, the foamed product density preferably falls within a range of 0.3 to 0.7 (g/cm³). The foamed member can have open cell foam or closed cell foam.

The rubber hardness (Asker C) of the foamed member of the present invention can be appropriately predetermined in accordance with use and production conditions. For example, the foamed member has a rubber hardness (Asker C) of about 40 to 90°. When the foamed member is employed as a feed/transport roller, particularly a reverse roller, the rubber hardness is preferably 50 to 80° (Asker C).

The foamed member of the present invention is characterized by exhibiting a ratio of maximum value (Max) of an output waveform to minimum value (Min) of the output waveform (Max/Min ratio) falling within a range of 1.00 to 1.40, preferably 1.00 to 1.20, the output waveform being obtained during measurement of friction coefficient.

The ratio (Max/Min) is obtained when friction coefficient is measured. Generally, friction coefficient of a sheet medium of paper or another material with respect to a foam material is measured while the sheet medium is in contact with the foam material under application of a load by a load cell or a similar apparatus. The output profile (waveform) is recorded, and the ratio is calculated from the maximum value (Max) and the minimum value (Min). No particular limitation is imposed on the type of output, and current, voltage, weight corresponding to load, etc. can be employed in determining the ratio.

### EXAMPLES

The present invention will next be described in more detail by way of examples, which should not be construed as limiting the invention thereto.

### Example 1

Diisocyanate (40 parts by weight) was added to bi-functional liquid polybutadiene of which both molecular chain ends are OH-terminated (number average molecular weight: 2,000, POLY-BD, product of Idemitsu Petrochemical Co., Ltd.) (100 parts by weight), and the mixture was stirred at 100° C. for 15 minutes.

The mixture liquid was further agitated for five minutes by means of a home-use hand mixer so as to incorporate air into the mixture. Subsequently, tri-functional polyol (number average molecular weight: 856, Placcel 308, product of Daicel Chem. Ind. Ltd.) (8 parts by weight) and 1,4-butanediol (number average molecular weight: 90, product of Mitsubishi Chemical Co., Ltd.) (8 parts by weight) were added to the mixture, and the resultant mixture was further stirred for one minute.

The stirred mixture (375 g) was injected into a mold (volume: 940 cm³) at 100° C. and allowed to react for one hour for curing. The cured product was polished and cut by use of a cut-off tool, thereby forming a foamed product having a roller shape.

### Example 2

Diisocyanate (28 parts by weight) was added to bi-functional liquid polyisoprene of which both molecular chain ends are OH-terminated (number average molecular weight: 2,000, POLY-IP, product of Idemitsu Petrochemical Co., Ltd.) (100 parts by weight), and the mixture was stirred at 100° C. for 15 minutes.

The mixture liquid was further agitated for five minutes by means of a home-use hand mixer so as to incorporate air into the mixture. Subsequently, tri-functional polyol (number average molecular weight: 4000, Placcel P3403, product of Daicel Chem. Ind.

Ltd.) (23 parts by weight) and 1,4-butanediol (number average molecular weight: 90, product of Mitsubishi Chemical Co., Ltd.) (4 parts by weight) were added to the mixture, and the resultant mixture was further stirred for one minute.

The stirred mixture (375 g) was injected into a mold (volume: 940 cm³) at 100° C. and allowed to react for one hour for curing. The cured product was polished and cut by use of a cut-off tool, thereby forming a foamed product having a roller shape.

### Example 3

The procedure of Example 1 was repeated, except that Placcel 308 (product of Daicel Chem. Ind. Ltd.) (25 parts by weight of) serving as a tri-functional polyol and diethylene glycol (number average molecular weight: 110, product of Mitsubishi Chemical Co., Ltd.) (7 parts by weight) serving as a short chain diol were added to the mixture liquid, thereby forming a foamed product in the roller shape.

### Example 4

The procedure of Example 2 was repeated, except that the amount of the stirred mixture injected into a mold was changed to 562 g, thereby forming a foamed product having a roller shape.

### Example 5

The procedure of Example 3 was repeated, except that diisocyanate (28 parts by weight) was added to polytetramethylene glycol (number average molecular weight: 2,000, PTMG2000, product of Sanyo Chemical Industries, Ltd.) (100 parts by weight), and the mixture was stirred at 100° C. for 15 minutes, thereby forming a foamed product having a roller shape.

### Example 6

Diisocyanate (40 parts by weight) was added to Poly-BD (product of Idemitsu Petrochemical Co., Ltd.) (100 parts by weight), and the mixture was stirred at 100° C. for 15 minutes.

The mixture liquid was further agitated for five minutes by means of a home-use hand mixer so as to incorporate air into the mixture. Subsequently, Placcel 308 (product of Daicel Chem. Ind. Ltd.) (51 parts by weight) and 1,3-propanediol (PD, number average molecular weight: 76) (1 part by weight) were added to the mixture, and the resultant mixture was further stirred for one minute.

Subsequently, the mixture liquid was further agitated for five minutes by means of a home-use hand mixer so as to incorporate air into the mixture. Placcel 308 (product of Daicel Chem. Ind. Ltd.) (12 parts by weight) and DEG (4 parts by weight) were added to the mixture, and the resultant mixture was further stirred for one minute.

The stirred mixture (562 g) was injected into a mold (volume: 940 cm³) at 100° C. and allowed to react for one hour for curing. The cured product was polished and cut by use of a cut-off tool, thereby forming a foamed product having a roller shape.

### Comparative Example 1

Diisocyanate (53 parts by weight) was added to bi-functional polyol of which both molecular chain ends are OH-terminated (number average molecular weight: 2,000, Placcel 220N, product of Daicel Chem. Ind. Ltd.) (100 parts by weight), and the mixture was stirred at 100° C. for 15 minutes.

The mixture liquid was further agitated for five minutes by means of a home-use hand mixer so as to incorporate air into the mixture. Subsequently, trimethylolpropane (number average molecular weight: 134, TMP, product of Mitsubishi Gas Chem. Co., Ltd.) (5 parts by weight) and 1,3-propanediol (number average molecular weight: 76) (7 parts by weight) were added to the mixture, and the resultant mixture was further stirred for one minute.

The stirred mixture (750 g) was injected into a mold (volume: 940 cm³) at 100° C. and allowed to react for one hour for curing. The cured product was polished and cut by use of a cut-off tool, thereby forming a foamed product having a roller shape.

### Comparative Example 2

Diisocyanate (28 parts by weight) was added to Placcel 220N (product of Daicel Chem. Ind. Ltd.) (100 parts by weight), and the mixture was stirred at 100° C. for 15 minutes.

The mixture liquid was further agitated for five minutes by means of a home-use hand mixer so as to incorporate air into the mixture. Subsequently, Placcel 308 (number average molecular weight: 856, product of Daicel Chem. Ind. Ltd.) (28 parts by weight) and 1,4-butanediol (number average molecular weight: 90) (1 part by weight) were added to the mixture, and the resultant mixture was further stirred for one minute.

The stirred mixture (375 g) was injected into a mold (volume: 940 cm³) at 100° C. and allowed to react for one hour for curing. The cured product was polished and cut by use of a cut-off tool, thereby forming a foamed product having a roller shape.

### Comparative Example 3

Diisocyanate (40 parts by weight) was added to Placcel 220N (product of Daicel Chem. Ind. Ltd.) (100 parts by weight), and the mixture was stirred at 100° C. for 15 minutes.

The mixture liquid was further agitated for five minutes by means of a home-use hand mixer so as to incorporate air into the mixture. Subsequently, Placcel P3403 (product of Daicel Chem. Ind. Ltd.) (40 parts by weight) and DEG (9 parts by weight) were added to the mixture, and the resultant mixture was further stirred for one minute.

The stirred mixture (562 g) was injected into a mold (volume: 940 cm³) at 100° C. and allowed to react for one hour for curing. The cured product was polished and cut by use of a cut-off tool, thereby forming a foamed product having a roller shape.

### Comparative Example 4

Diisocyanate (40 parts by weight) was added to bi-functional polyol of which both molecular chain ends are OH-terminated (100 parts by weight) (number average molecular weight: 2,000, Placcel CD220, product of Daicel Chem. Ind. Ltd.), and the mixture was stirred at 100° C. for 15 minutes.

The mixture liquid was further agitated for five minutes by means of a home-use hand mixer so as to incorporate air into the mixture. Subsequently, Placcel-308 (product of Daicel Chem. Ind. Ltd.) (9 parts by weight) and 1,3-PD (7 parts by weight) were added to the mixture, and the resultant mixture was further stirred for one minute.

The stirred mixture (562 g) was injected into a mold (volume: 940 cm³) at 100° C. and allowed to react for one hour for curing. The cured product was polished and cut by use of a cut-off tool, thereby forming a foamed product having a roller shape.

### Comparative Example 5

Diisocyanate (39 parts by weight) was added to Placcel 3403 (product of Daicel Chem. Ind. Ltd.) (100 parts by weight), and the mixture was stirred at 100° C. for 15 minutes.

The mixture liquid was further agitated for five minutes by means of a home-use hand mixer so as to incorporate air into the mixture. Subsequently, Placcel-308 (10 parts by weight) and DEG (11 parts by weight) were added to the mixture, and the resultant mixture was further stirred for one minute.

The stirred mixture (375 g) was injected into a mold (volume: 940 cm³) at 100° C. and allowed to react for one hour for curing. The cured product was polished and cut by use of a cut-off tool, thereby forming a foamed product having a roller shape.

### Comparative Example 6

Diisocyanate (28 parts by weight) was added to Placcel 220N (product of Daicel Chem. Ind. Ltd.)(100 parts by weight) serving as a polyol, and the mixture was stirred at 100° C. for 15 minutes while air was evacuated by use of a vacuum pump.

Subsequently, Placcel 308 (product of Daicel Chem. Ind. Ltd.) (28 parts by weight) and 1,4-BD (1 part by weight) were added to the stirred mixture, and the resultant mixture was further agitated for one minute such that incorporation of air into the mixture was prevented.

The stirred mixture was injected into a mold at 100° C. and allowed to react for one hour for curing. The cured product was polished and cut by use of a cut-off tool, thereby forming a solid roller.

### Comparative Example 7

The procedure of Comparative Example 6 was repeated, except that POLY-BD (product of Idemitsu Petrochemical Co., Ltd.) was employed as a polyol, thereby forming a solid roller.

### Comparative Example 8

The procedure of Comparative Example 6 was repeated, except that POLY-IP (product of Idemitsu Petrochemical Co., Ltd.) was employed as a polyol, thereby forming a solid roller.

### Comparative Example 9

Diisocyanate (40 parts by weight) was added to POLY-BD (product of Idemitsu Petrochemical Co., Ltd.) (100 parts by weight), and the mixture was stirred at 100° C. for 15 minutes.

The mixture liquid was further agitated for five minutes by means of a home-use hand mixer so as to incorporate air into the mixture. Subsequently, TMP (4 parts by weight) and 1,3-PD (5 parts by weight) were added to the mixture, and the resultant mixture was further stirred for one minute.

The stirred mixture (375 g) was injected into a mold (volume: 940 cm³) at 100° C. and allowed to react for one hour for curing. The cured product was polished and cut by use of a cut-off tool, thereby forming a foamed product having a roller shape.

### Comparative Example 10

Diisocyanate (40 parts by weight) was added to Poly-IP (product of Idemitsu Petrochemical Co., Ltd.) (100 parts by weight), and the mixture was stirred at 100° C. for 15 minutes.

The mixture liquid was further agitated for five minutes by means of a home-use hand mixer so as to incorporate air into the mixture. Subsequently, PCL-308 (51 parts by weight) and 1,3-propanediol (number average molecular weight: 76) (1 part by weight) were added to the mixture, and the resultant mixture was further stirred for one minute.

The stirred mixture (375 g) was injected into a mold (volume: 940 cm³) at 100° C. and allowed to react for one hour for curing. The cured product was polished and cut by use of a cut-off tool, thereby forming a foamed product having a roller shape.

### Comparative Example 11

Diisocyanate (40 parts by weight) was added to polytetramethyleneglycol (100 parts by weight) (PTMG2000, product of Sanyo Chemical Industries, Ltd.), and the mixture was stirred at 100° C. for 15 minutes.

The mixture liquid was further agitated for five minutes by means of a home-use hand mixer so as to incorporate air into the mixture. Subsequently, TMP (1.5 parts by weight) and 1,4-BD (8 parts by weight) were added to the mixture, and the resultant mixture was further stirred for one minute.

The stirred mixture (375 g) was injected into a mold (volume: 940 cm³) at 100° C. and allowed to react for one hour for curing. The cured product was polished and cut by use of a cut-off tool, thereby forming a foamed product having a roller shape.

### Test Example 1

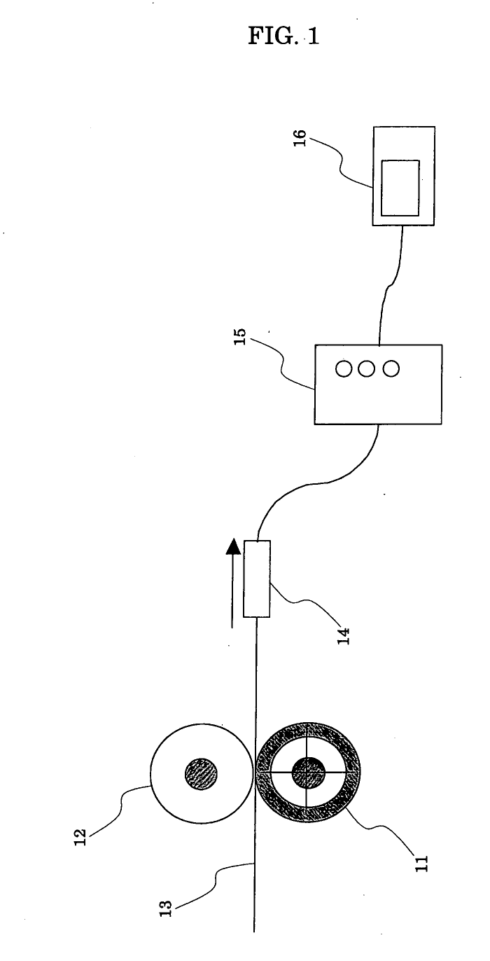

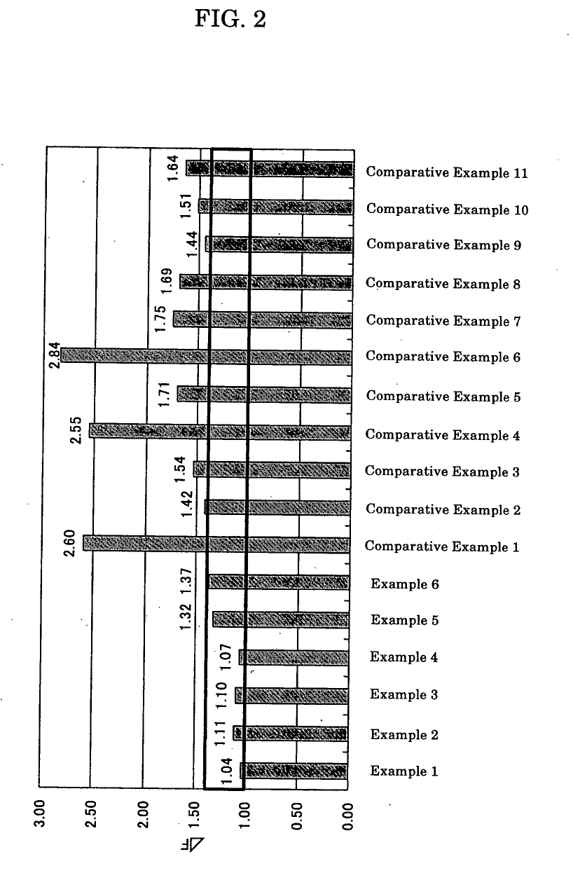

Each of the foamed rollers of Examples 1 to 6 and Comparative Examples 1 to 11 was subjected to friction coefficient measurement by means of an apparatus shown in FIG. 1, and an output waveform was obtained. Specifically, as shown in FIG. 1, a free roller 12 which was rotatably sustained was pressed against an affixed sample roller 11 at a predetermined load of 200 gf. A test sheet 13 inserted therebetween was conveyed via a load cell 14 at 20 mm/sec. The output from the load cell 14 was detected by means of a detector 16 connected thereto via an amplifier 15. The ratio of maximum value (Max) to minimum value (Min), observed in the waveform; i.e., Max/Min=ΔF, was calculated. The measurement was carried out at 23° C. and an RH of 55%. The results are shown in FIG. 2 and Table 1.

### Test Example 2

As a sheet-separation roller, each of the foamed rollers of Examples 1 to 6 and Comparative Examples 1 to 11 was attached to an automatic document feeder (ADF) (14 ppm (A4)) of a copying machine, and 10 plain paper sheets (A4) (RICOPY PPC sheet, TYPE 6200; product of Ricoh Company, Ltd.) were sequentially conveyed through the roller at 10° C. and an RH of 30%. Generation of anomalous noises was confirmed by sensory means. The results are also shown in Table 1.

TABLE 1

| | | Mol. weight | Short chain | TRI | Foamed product | | Anomalous |
|---|---|---|---|---|---|---|---|
| | Polyol | of TRI | diol mol. wt. | content % | density | ΔF | noises |
| Ex. 1 | Butadiene | 856 | 90 | 15 | 0.4 | 1.04 | No |
| Ex. 2 | Isoprene | 4,000 | 90 | 15 | 0.4 | 1.11 | No |
| Ex. 3 | Butadiene | 856 | 110 | 40 | 0.4 | 1.10 | No |
| Ex. 4 | Isoprene | 4,000 | 90 | 15 | 0.6 | 1.07 | No |
| Ex. 5 | PTMG | 856 | 110 | 40 | 0.6 | 1.32 | No |
| Ex. 6 | Butadiene | 856 | 76 | 85 | 0.6 | 1.37 | No |
| Comp. | Caprolactone | 134 | 76 | 40 | 0.8 | 2.60 | Yes |
| Ex. 1 | | | | | | | |
| Comp. | Caprolactone | 856 | 90 | 85 | 0.4 | 1.42 | Yes |
| Ex. 2 | | | | | | | |
| Comp. | Caprolactone | 4,000 | 110 | 15 | 0.6 | 1.54 | Yes |
| Ex. 3 | | | | | | | |
| Comp. | Carbonate | 856 | 76 | 15 | 0.6 | 2.55 | Yes |
| Ex. 4 | | | | | | | |
| Comp. | Ether-Ester | 856 | 110 | 15 | 0.4 | 1.71 | Yes |
| Ex. 5 | | | | | | | |
| Comp. | Caprolactone | 856 | 90 | 15 | solid | 2.84 | Yes |
| Ex. 6 | | | | | | | |
| Comp. | Butadiene | 856 | 90 | 15 | solid | 1.75 | Yes |
| Ex. 7 | | | | | | | |
| Comp. | Isoprene | 856 | 90 | 15 | solid | 1.69 | Yes |
| Ex. 8 | | | | | | | |
| Comp. | Butadiene | 134 | 76 | 40 | 0.4 | 1.44 | Yes |
| Ex. 9 | | | | | | | |
| Comp. | Isoprene | 856 | 90 | 86 | 0.8 | 1.51 | Yes |
| Ex. 10 | | | | | | | |
| Comp. | PTMG | 134 | 90 | 15 | 0.4 | 1.64 | Yes |
| Ex. 11 | | | | | | | |

TRI: tri-functional component

As is clear from Table 1, no anomalous noises were generated when the foamed rollers of Examples 1 to 6, exhibiting a ΔF (Max/Min) falling within a range of 1.0 to 1.4, were employed. However, when the foamed rollers of Comparative Examples 1 to 5 produced from a polyol other than a diene polyol or PTMG and exhibiting a large ΔF value were employed, anomalous noises were confirmed. When the foamed rollers of Comparative Examples 6 to 8, which assumed hard solid, anomalous noises were confirmed. When the foamed rollers of Comparative Examples 9 and 11, which were produced from a diene polyol, or PTMG and a tri-functional polyol having a small molecular weight, were employed, anomalous noises were confirmed. Although the foamed roller of Comparative Example 10 was produced from a diene polyol and a tri-functional polyol having a large molecular weight, the foamed product density was as high as 0.8. In this case, ΔF was 1.51 (greater than 1.4), and anomalous noises were confirmed.

### Example 7

A polyol (100 parts by weight) produced through dehydration condensation of a dibasic acid and 1,9-nonanediol and 2-methyloctanediol, MDI (30 parts by weight), diethylene glycol (DEG) (6 parts by weight) serving as a chain-extender, and P3403 (molecular weight: 4,000, containing an ester moiety and an ether moiety in the molecule thereof, tri-functional component: 15%) (22 parts by weight) serving as a cross-linking agent were mixed with stirring (mechanical frothing). The mixture (400 g) was poured into a mold (inner volume: 1,000 cm³) which had been heated in advance at 120° C., and cured at 120° C. for 1.5 hours.

The cured product was aged by heating at 100° C. for 12 hours, followed by polishing and cutting by use of a cut-off tool, thereby producing a sheet-separation roller (outer diameter: 25 mm, inner diameter: 15 mm, and width: 25 mm). The roller was found to have a foamed product density ((amount of produce in the mold/volume of the mold)×100) of 0.4 g/cm³ and exhibit a ΔF of 1.08.

Tri-functional component content (%) and ΔF were calculated by the following equations:

Tri-functional component content (%)=amount of cross-linking agent (mol)/(amount of chain-extender (mol)+amount of cross-linking agent (mol))×100, and

ΔF=maximum value (Max) of an output waveform/minimum value (Min) of the output waveform, wherein the output waveform is obtained during measurement of friction coefficient.

### Example 8

The procedure of Example 7 was repeated, except that the foamed product density was 0.6 g/cm³ (mold amount: 600 g), to thereby produce a roller. The roller exhibited a ΔF of 1.12.

### Example 9

The procedure of Example 7 was repeated, except that DEG (5 parts by weight) and P3403 (50 parts by weight) were used (i.e., tri-functional component: 40%), to thereby produce a roller. The roller exhibited a ΔF of 1.15.

### Comparative Example 12

The procedure of Example 7 was repeated, except that DEG (6 parts by weight) and PCL 308 (molecular weight: 800, containing an ester moiety but no ether moiety) (6 parts by weight) were used (i.e., tri-functional component: 15%), to thereby produce a roller. The roller exhibited a ΔF of 1.53.

### Comparative Example 13

The procedure of Example 7 was repeated, except that DEG (6 parts by weight) and trimethylolpropane (TMP) (molecular weight: 134) (1 part by weight) were used (i.e., tri-functional component: 15%), to thereby produce a roller. The roller exhibited a ΔF of 1.95.

### Test Example 3

Each of the sheet-separation rollers of Examples 7 to 9 and Comparative Examples 12 and 13 was subjected to friction coefficient measurement by means of an apparatus shown in FIG. 1, and an output waveform was obtained. The ratio of maximum value (Max) to minimum value (Min), observed in the waveform; i.e., Max/Min=ΔF, was calculated. The measurement was carried out at 23° C. and an RH of 55%. The results are shown in Table 2.

### Test Example 4

As a sheet-separation roller, each of the foamed rollers of Examples 7 to 9 and Comparative Examples 12 to 13 was attached to an automatic document feeder (ADF) (14 ppm (A4)) of a copying machine, and 10 plain paper sheets (A4) (RICOPY PPC sheet, TYPE 6200; product of Ricoh Company, Ltd.) were sequentially conveyed through the roller at 10° C. and an RH of 30%. Generation of anomalous noises was confirmed by sensory means. The results are also shown in Table 2.

### Test Example 5

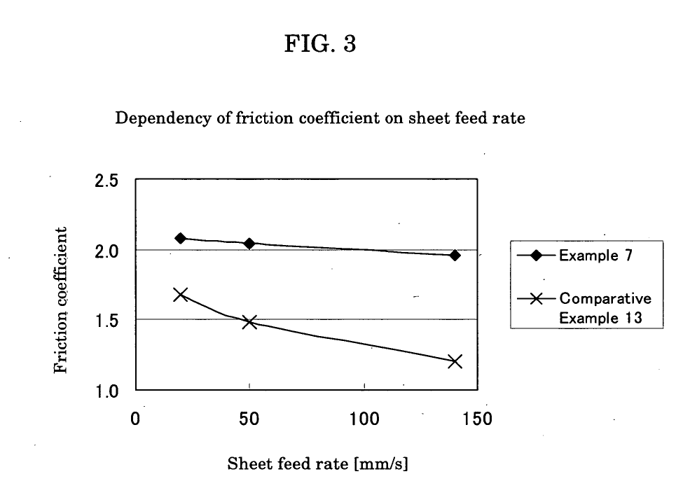

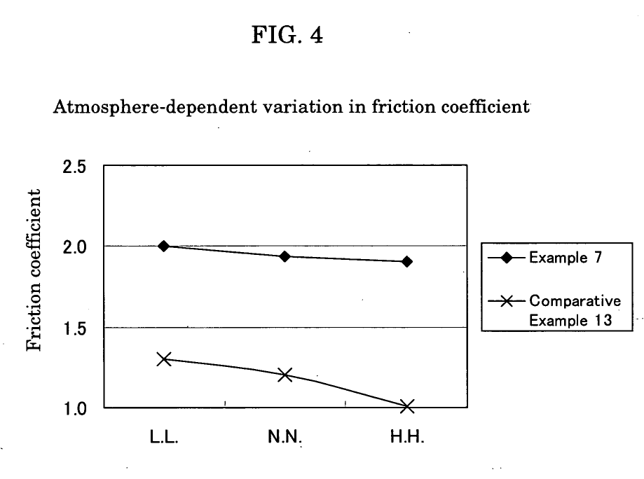

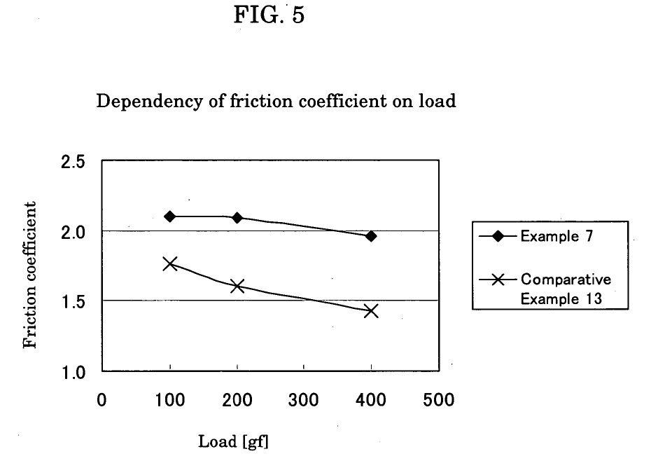

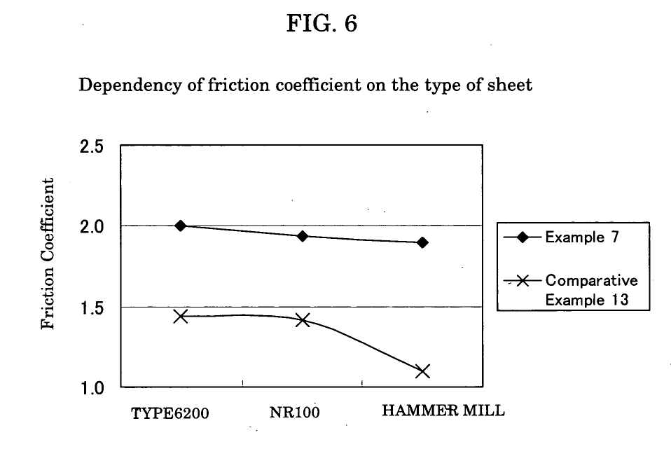

Each of the sheet-separation rollers of Example 7 and Comparative Example 13 was investigated in terms of dependency of friction coefficient on sheet feed rate, on load, and on the type of sheet, and atmosphere-dependent variation in friction coefficient. The results are shown in FIGS. 3 to 6.

TABLE 2

| | | Mol. wt. | Short chain | TRI | Foamed product | | Anomalous |
|---|---|---|---|---|---|---|---|
| | Polyol | of TRI | diol | content % | density | ΔF | noises |
| Ex. 7 | ND-MOD/AA | 4,000 | 110 | 15 | 0.4 | 1.1 | No |
| Ex. 8 | ND-MOD/AA | 4,000 | 110 | 15 | 0.6 | 1.1 | No |
| Ex. 9 | ND-MOD/AA | 4,000 | 110 | 40 | 0.4 | 1.2 | No |
| Comp. Ex. 12 | ND-MOD/AA | 856 | 110 | 15 | 0.4 | 1.5 | Yes |
| Comp. Ex. 13 | ND-MOD/AA | 134 | 110 | 15 | 0.4 | 2 | Yes |

TRI: tri-functional component

The results of Test Examples 3 to 5 indicates that, when a foamed member is produced from a polyol obtained through dehydration condensation of a dibasic acid and 1,9-nonanediol and 2-methyloctanediol, and a tri-functional polyol (molecular weight: 4,000) containing an ester moiety and an ether moiety in the molecule thereof, the rollers produced therefrom exhibit a ΔF (Max/Min) of 1.0 to 1.2 without generation of anomalous noises. However, when a polyol having a low molecular weight and an ether moiety but no ester moiety, or a TMP having a low molecular weight is employed, the rollers produced therefrom (Comparative Examples 12 and 13) exhibit a large ΔF value with generation of anomalous noises. Each of the sheet-separation rollers of Example 7 and Comparative Example 13 was investigated in terms of dependency of friction coefficient on sheet feed rate, on load, and on the type of sheet, and atmosphere-dependent variation in friction coefficient. As is clear from FIGS. 3 to 6, the sheet-separation roller of Example 7 assures more stable friction-related performance operation, as compared with and Comparative Example 13.

As described hereinabove, according to the present invention, a foamed product having a predetermined foamed product density is produced from a diene polyol or PTMG as the first polyol and a diene (tri-functional) polyol having a number average molecular weight of 500 to 5,000. A cured product of polyurethane foam exhibits a ratio of maximum value (Max) of an output waveform to minimum value (Min) of the output waveform (Max/Min ratio) falling within a range of 1.00 to 1.40, the output waveform being obtained during measurement of friction coefficient. Thus, generation of anomalous noises can be prevented.

What is claimed is:

1. A foamed member formed from polyurethane foam, the polyurethane foam being produced by reacting a polyisocyanate compound with a fiest polyol in the presence of a cross-linking agent;
wherein the first polyol is selected from among
a polytetramethylene ether glycol and
a diene polyol having at least one double bond in the molecular chain thereof, and the first polyol has a number average molecular weight of 1,000 to 4,000,
wherein the cross-linking agent comprising
a short-chain diol and
a second polyol having at least three functionalities and a number average molecular weight of 500 to 5,000, wherein the foamed member comprises a foamed reaction cured product having a foamed product density (weight of the product in a mold [g]/volume of the mold [cm³]) of 0.3 to 0.9 [g/cm³] and exhibits a ratio of maximum value (Max) of an output waveform to minimum value (Min) of the output waveform (Max/Min ratio) falling within a range of 1.00 to 1.40, the output waveform being obtained during measurement of friction coefficient.

2. A foamed member according to claim 1, wherein the Max/Min ratio falls within a range of 1.00 to 1.20.

3. A foamed member according to claim 1, wherein the cross-linking agent contains the second polyol in an amount of 5 to 40 mol %.

4. A foamed member according to claim 1, wherein the polyisocyanate compound is 4,4′-diphenylmethane diisocyanate (MDI).

5. A foamed member according to claim 1, wherein the short-chain diol has a number average molecular weight of 80 to 160.

6. A foamed member according to claim 1, wherein the diene polyol is selected from a butadiene polyol and an isoprene polyol.

7. A foamed member according to claim 1, wherein the diene polyol is produced through dehydration condensation of a dibasic acid and 1,9-nonanediol and 2-methyloctanediol.

8. A foamed member according to claim 7, wherein the second polyol contains, in the molecule thereof, an ether moiety and an ester moiety.

9. A foamed member according to claim 7, wherein the second polyol has a molecular weight falling within a range of 1,800 to 5,000.

10. A feed/transport roller comprising a foamed member as recited in any one of claims 1 to 9.

11. A sheet-separation roller comprising a foamed member as recited in any one of claims 1 to 9.
